(19) United States
(12) Patent Application Publication
(10) Pub. No.: US 2015/0122236 A1
(43) Pub. Date: May 7, 2015

(54) Valves

(71) Applicant: Perkins Engines Company Limited, Cambridgeshire (GB)

(72) Inventors: Paul Wilkinson, Cambridgeshire (GB); Jean-Yves Tillier, Cambridgeshire (GB); Martin Antony Parsons, Cambridgeshire (GB)

(73) Assignee: PERKINS ENGINES COMPANY LIMITED, Cambridgeshire (GB)

(21) Appl. No.: 14/396,162

(22) PCT Filed: Apr. 22, 2013
(86) PCT No.: PCT/GB2013/051014

§ 371 Date: Oct. 22, 2014

(30) Foreign Application Priority Data
May 1, 2012 (GB) 1207596.6

(51) Int. Cl. F02M 25/07

(52) U.S. Cl. CPC F02M 25/0788; F02M 25/0794; F02M 25/0797
USPC 123/568.11

(57) ABSTRACT

A valve suitable for use as an exhaust gas recirculation valve in an engine includes a valve housing defining an interior space, a valve stem and a valve member, which may be a poppet, mounted on said valve stem. The valve member is arranged to move between open and closed positions. The valve further includes a mounting member, which may be a bush, located in the interior space, with said valve stem supported within the mounting member. The valve member includes a deflector to direct fluid away from the mounting member when the valve member is in an open position.

### FIELD

The present disclosure relates to improvements in valves and in particular to a valve suitable for use as an exhaust gas recirculation valve.

### BACKGROUND

Exhaust gas recirculation (EGR) is a known technique for use in internal combustion engines (petrol or diesel) wherein a portion of an engine's exhaust gas is recirculated back to the engine cylinders. EGR may be used to reduce emissions of oxides of nitrogen including NO and NO₂.

A typical EGR system may include a conduit, or other structure, fluidly connecting a portion of the exhaust path of an engine with a portion of the air intake system of the engine, thereby forming an EGR path. Different amounts of exhaust gas recirculation may be desirable under different engine operating conditions and, in order to regulate the amount of exhaust gas recirculation, such systems typically employ an EGR valve that is disposed at some point in the EGR path.

The EGR valve may be located either upstream (‘hot-side valve’) or downstream (‘cold side valve’) of an EGR cooler which is located in the EGR path to cool the exhaust gas before it is mixed with the charge air. In addition, the EGR gas take off point may run from before the turbine to post turbocharger compressor (high pressure loop EGR) or from after the turbine to before the turbocharger compressor (low pressure loop EGR).

EGR valves may be any type configured to open or close off the EGR path, and single or dual poppet valves are often used. However, under some engine running conditions poppet valves can occasionally become stuck and not respond to control inputs. In particular when the valve is opened, due to the velocity and direction of EGR gas flow, soot or other particulate matter from the EGR gas stream can enter the valve and become lodged between the valve stem (shaft) and the shaft bush.

It is therefore an object of the present disclosure to provide a solution to the aforementioned problem.

### SUMMARY OF THE INVENTION

The present disclosure therefore provides a valve for use in an exhaust gas recirculation system comprising:

a valve housing defining an interior space;

a valve stem;

at least one valve member mounted on said valve stem, said at least one valve member being arranged to move between open and closed positions; and

a mounting member located in the interior space, with said valve stem supported within the mounting member; wherein said at least one valve member comprises a deflector to direct fluid away from the mounting member when the at least one valve member is in an open position, said at least one valve member having a first surface and the deflector comprises a raised portion extending from said first surface and substantially around the valve stem enclosing an area greater than the mounting member.

The present disclosure further provides an exhaust gas recirculation system comprising the aforesaid valve and an exhaust gas recirculation mixer module in which the valve is mounted in the exhaust gas recirculation mixer module.

The present disclosure further provides and engine comprising the aforesaid exhaust gas recirculation system.

### BRIEF DESCRIPTION OF THE DRAWINGS

FIG. 1 is diagrammatic representation of an engine with a high pressure loop exhaust gas recirculation system with a cold side valve;

FIG. 2 is a perspective view of an exhaust gas recirculation mixer module of the exhaust gas recirculation system of FIG. 1;

FIG. 3 is a cross sectional side elevation of the exhaust gas recirculation mixer module of FIG. 2;

FIG. 4 is a cross sectional side elevation of a section of the exhaust gas recirculation valve with a deflector; and

FIG. 5 is a cross sectional side elevation of a section of the exhaust gas recirculation valve with a different construction of deflector.

### DETAILED DESCRIPTION

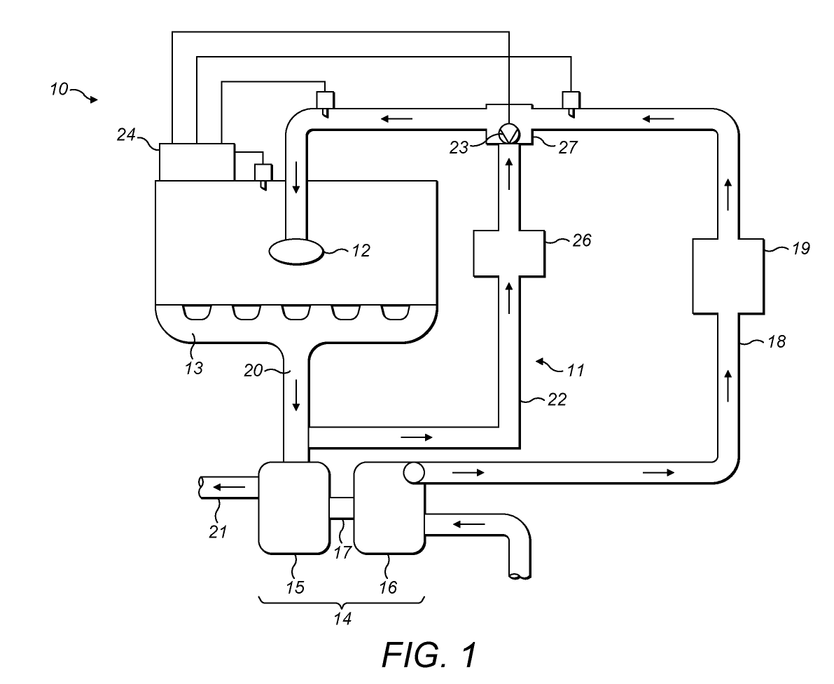

Referring to FIG. 1, there is shown an exemplary engine 10 having a high pressure loop exhaust gas recirculation (EGR) system 11 with a cold side valve. The engine 10 may be any kind of suitable engine, such as an internal combustion engine and in particular a diesel fuelled compression-ignition (CI) internal combustion engine. The internal combustion engine 10 may include a plurality of combustion cylinders housed in a crankcase. Each combustion cylinder may be fluidly coupled with an intake manifold 12 and with an exhaust manifold 13. While single intake and exhaust manifolds 12, 13 are shown, it should be understood that more than one intake or exhaust manifolds 12, 13 may be used, with each intake or exhaust manifold 12, 13 coupled to a plurality of combustion cylinders. A fuel, such as diesel fuel, or fuel air mixture may be introduced into each combustion cylinder and combusted therein, in a known manner. The engine 10 may further comprise a turbocharger 14.

The turbocharger 14 may include a turbine 15 and a compressor 16 having a turbine wheel and a compressor wheel (not shown) respectively, both mounted on a common turbocharger shaft 17. The compressor 16 may receive charge from a source such as ambient air, and may supply compressed charge gas to the intake manifold 12 of the engine 10 via a charge air conduit 18. The compressed charge gas may be passed through a charge air cooler 19 before it passes into the intake manifold 12.

The turbine 15 may be fluidly connected with the exhaust manifold 13, by means of an exhaust conduit 20, and to an exhaust system (not shown) of engine 10, by means of a further conduit 21. The exhaust system may include an after treatment device which removes combustion products from the exhaust gas stream and one or more mufflers to dampen engine noise, before the exhaust gas is discharged to an ambient environment. The emission of the engine 10 is commonly referred to as exhaust gas but may in reality be a mixture of gas, other fluids such as liquids, and even solids, comprising for example CO₂, H₂O, NOx and particulate matter.

Although not shown in FIG. 1, the turbocharger 14 may be regarded as being a turbocharging arrangement comprising multiple turbochargers 14 in, for example, a series configuration.

The EGR system 11 may comprise an EGR conduit, which in the case of a high pressure loop EGR system with a cold side EGR valve, fluidly connects the exhaust conduit 20 and the intake manifold 12, so that at least a portion of the exhaust gas may be recirculated from the exhaust conduit 20 to the intake manifold 12. This portion of recirculated exhaust gas will be referred to herein as “EGR gas”. The EGR system 11 may further comprise a valve 23, which may be configured to be controlled by a controller 24 so as to vary the quantity of EGR gas flowing through the EGR conduit 22. The EGR gas may be passed through an EGR cooler 26 to cool the EGR gas before it arrives at the intake manifold 12. The order of the EGR cooler 26 and the EGR valve 23 may be reversed to give a hot side or a cold side EGR valve 23.

The controller 24 may be a single controller or comprise a plurality of independent or linked control units. The controller 24 may be configured to receive and process signals from various sensor arrangements and may be further configured to determine the operating conditions of the engine 10 and or the EGR system 11.

An EGR mixer module 27 may be configured to mix the intake air from the charge air conduit 18 together with the EGR gas from EGR conduit 22 to create a mixture having a desirable level of homogeneity. In some embodiments the EGR mixer module 27 may simply be a conduit and/or the intake manifold 12, which may be provided with features such as for example vanes, valves, or labyrinths to increase the mixing characteristics if desired. In some embodiments the EGR mixer module 27 may include a dedicated fluid mixer assembly.

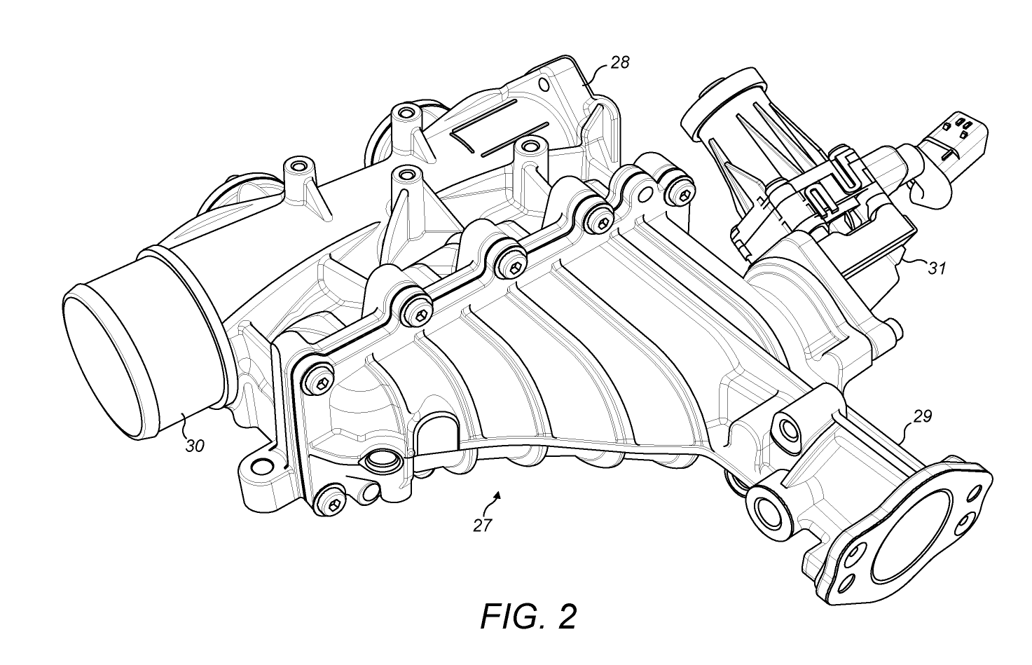

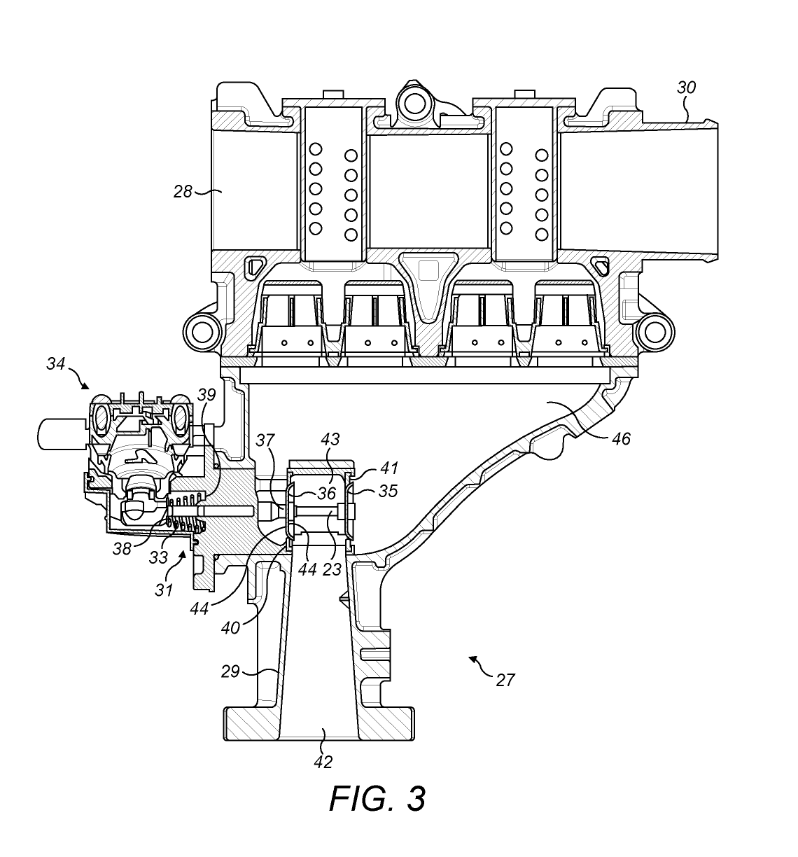

The EGR valve 23 may be located in the EGR mixer module 27 (see FIGS. 2 and 3). The EGR mixer module 27 may have a charge air inlet 28, which may be fluidly connected with charge air conduit 18, and an exhaust gas inlet 29, which may be fluidly connected with the EGR conduit 22. Mixed EGR gas and charge air may pass out of the EGR mixer module 27 via EGR mixer module outlet 30, which may be fluidly connected to the intake manifold 12.

The EGR valve 23 may be configured to open or close off the exhaust gas inlet 29, such that the position of EGR valve 23 (valve position) determines the flow rate through EGR conduit 22 (EGR flow rate). In some embodiments, EGR valve 23 may be controllable to allow varying EGR flow rates and/or selectively completely block EGR gas flow. Alternatively it may be a two position on/off system.

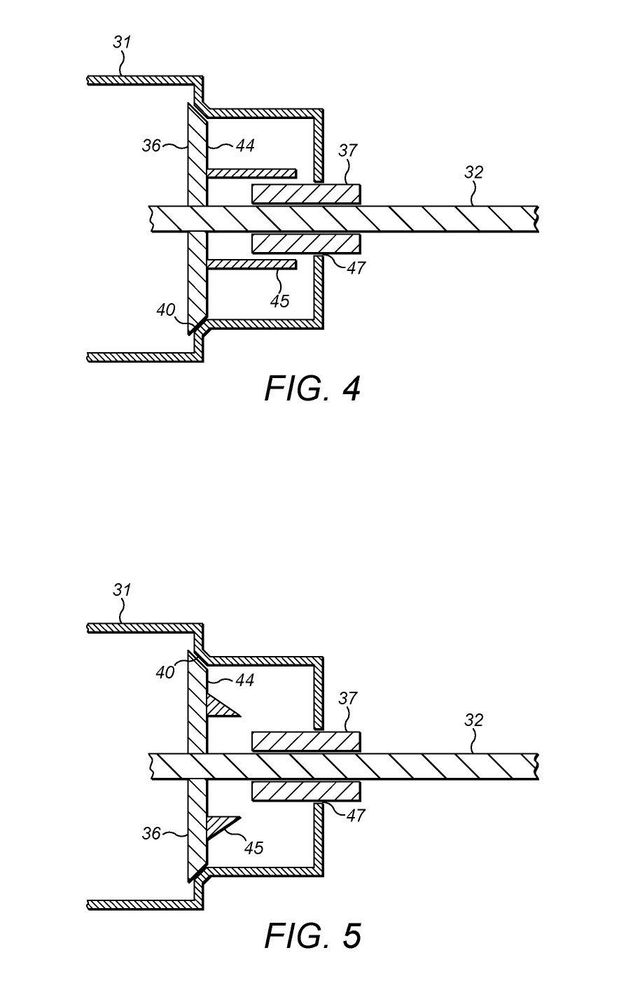

The EGR valve 23 of the present disclosure may be a poppet valve and may comprise a valve housing 31, a valve stem 32, a valve spring 33 and a valve actuator 34. First and second valve members, which may be in the form of a first poppet 36 and a second poppet 35, may be mounted, with a space therebetween, towards one end of the valve stem 32. The valve stem 32 is supported by a mounting member, such as a cylindrical alignment bush 37, as it passes through an aperture 47 in the valve housing 31 (see FIGS. 4 and 5). The bush 37 acts as a linear guide to allow the valve stem 32 to move in a linear direction relative to the bush 37 with a minimum of frictional resistance. Although the drawings illustrate a dual poppet valve, the EGR valve 23 may be a single poppet valve. At the opposing end of the valve stem 32 is a flange 38 and the valve spring 33 is located around this end of the valve stem 32 between the flange 38 and a recess 39 in the valve housing 31. The spring force acts between the flange 38 and the valve housing 31 to maintain the EGR valve 23 in a closed position.

A section of the valve housing 31, which may be located directly in line with a bore 42 of the exhaust gas inlet 29, may further define a chamber 43 having two outlets defined by a pair of valve seats 40, 41. In the valve closed position, the peripheries of the poppets 35, 36 may sealingly engage with the valve seats 40, 41 to restrict any flow of EGR gas into the EGR mixer module 27. In the valve open position, the poppets 35, 36 may move away from the valve seats 40, 41 to allow EGR gas to flow into the EGR mixer module 27. The EGR valve 23 may be actuatable to move between the closed and (one or more) open positions.

The first (or sole) poppet 36 may have a first surface 44, the periphery of which may seal against a valve seat 40. This first surface 44 may be provided with a deflector 45, which may be a raised area such as a ridge, tubular projection, flange or the like, which may encircles the valve stem 32 and may have an internal diameter greater than the external diameter of the bush 37. The design of the deflector 45 may be selected to protect against soot entering aperture 47 and settling generally on the valve stem 32/bush 37 interface. It may do this by preventing direct impingement of the EGR gas stream in this critical region, and thereby minimising the risk of movement of the EGR valve 23 from being impaired. The deflector 45 may be integrally formed with the first surface 44, or separately formed and attached thereto.

### INDUSTRIAL APPLICABILITY

During operation of the engine 10, a fuel, such as diesel fuel, may be injected into the combustion cylinders and combusted. Exhaust gas produced as a result of the combustion process may be directed from the combustion cylinders to the exhaust manifold 13. At least a portion of the exhaust gas within the exhaust manifold 13 may be directed to flow through and drive the turbine 15. The spent exhaust gas may be discharged from the turbine 15 to atmosphere, via the exhaust system, before which it may be treated to reduce emissions. Another part of the exhaust gas, namely the EGR gas, may be directed to the EGR mixer module 27. As stated previously the EGR gas may be cooled before passing into the EGR mixer module 27.

The turbine 15 may transmit power to the compressor 16 via turbocharger shaft 17 on which they may both be mounted. The compressor 16 may draw in charge air (or other gas) and compress it. The compressed charge air may be discharged from the compressor 16 and may pass along the charge air conduit 18 to the intake manifold 12 and, where included, the EGR mixer module 27. As stated previously, the compressed combustion gas may be cooled by EGR cooler 26 before passing into the EGR mixer module 27/intake manifold 12.

When the EGR valve 23 is in a closed position, no EGR gas enters the EGR mixer module and the compressed charge air passes through the EGR mixer module 27 to the intake manifold 12 for combustion.

When the EGR valve 23 is in an open position, EGR gas may enter the EGR mixer module 27 via the exhaust gas inlet 29 and may flow into an upper chamber 46 thereof where it may mix with the clean compressed charge air. The mixture may then be directed to the intake manifold 12 for combustion.

When the EGR valve 23 is in an open position, the EGR gas, which carries soot and other particulate matter resulting from the combustion process, may flow through the gap created between the first poppet 36 and the valve seat 40 and around the valve stem 32. The deflector 45 directs the EGR gas away from the interface between the bush 37 and the valve stem 32, thereby to prevent the particulate matter from lodging in the gap between the bush 37 and the valve stem 32.

Consequently the likelihood of the EGR valve 23 becoming stuck and not responding to control inputs is reduced.

1. A valve for use in an exhaust gas recirculation system comprising:
a valve housing defining an interior space;
a valve stem;
at least one valve member mounted on said valve stem, said at least one valve member being arranged to move between open and closed positions; and
a mounting member located in the interior space, with said valve stem supported within the mounting member;
wherein said at least one valve member comprises a deflector to direct fluid away from the mounting member when the at least one valve member is in an open position, said at least one valve member having a first surface and the deflector comprises a raised portion extending from said first surface and substantially around the valve stem enclosing an area greater than the mounting member.

2. A valve as claimed in claim 1 further comprising a pair of valve members mounted on the valve stem with a space therebetween.

3. A valve as claimed in claim 1 in which at least one said valve member is a poppet.

4. A valve as claimed in claim 1 in which the mounting member is a bush.

5. A valve as claimed in claim 1 in which at least one said deflector is formed integrally with its respective valve member.

6. A valve as claimed in claim 1 in which at least one said deflector is attached to its respective valve member.

7. A valve as claimed in claim 1 comprising an exhaust gas recirculation valve.

8. A valve as claimed in claim 1 in which at least one said deflector comprises an annular member projecting from its respective valve member.

9. A valve as claimed in claim 1 in which at least one said deflector has an outer face which is profiled to direct fluid away from the mounting member when the valve member is in an open position.

10. An exhaust gas recirculation system comprising a valve as claimed in claim 1 and an exhaust gas recirculation mixer module in which the valve is mounted in the exhaust gas recirculation mixer module.

11. An engine comprising the exhaust gas recirculation system of claim 10.

12. A valve as claimed in claim 2 in which at least one said valve member is a poppet.

13. A valve as claimed in claim 2 in which the mounting member is a bush.

14. A valve as claimed in claim 2 in which at least one said deflector is formed integrally with its respective valve member.

15. A valve as claimed in claim 2 in which at least one said deflector is attached to its respective valve member.

16. A valve as claimed in claim 2 comprising an exhaust gas recirculation valve.

17. A valve as claimed in claim 2 in which at least one said deflector comprises an annular member projecting from its respective valve member.

18. A valve as claimed in claim 2 in which at least one said deflector has an outer face which is profiled to direct fluid away from the mounting member when the valve member is in an open position.

19. An exhaust gas recirculation system comprising a valve as claimed in claim 1 and an exhaust gas recirculation mixer module in which the valve is mounted in the exhaust gas recirculation mixer module.

20. A valve as claimed in claim 15 in which at least one said deflector has an outer face which is profiled to direct fluid away from the mounting member when the valve member is in an open position.
